(19) United States
(12) Patent Application Publication
(10) Pub. No.: US 2024/0412635 A1
(43) Pub. Date: Dec. 12, 2024

(54) DEVICE AND METHOD FOR VEHICLE-TO-VEHICLE COMMUNICATION

(71) Applicant: David Newsham, Rialto, CA (US)

(72) Inventor: David Newsham, Rialto, CA (US)

(21) Appl. No.: 18/208,221

(22) Filed: Jun. 9, 2023

(51) Int. Cl. G08G 1/16

(52) U.S. Cl. CPC G08G 1/161

(57) ABSTRACT

A vehicle-to-vehicle communication device and method for communicating with a plurality of vehicles are disclosed. The device comprises a first communication unit of a vehicle configured to communicate with a second communication unit of at least one or more vehicles when in range. The first communication unit communicates with the second communication unit via a communication protocol. The communication protocol is short radio frequencies or the like. The device alerts or indicates users or drivers about the presence of other off-roading vehicles nearby or in proximity to avoid collision during traveling. The alert is given either through an audio signal or light. The device communicates with other devices with similar communication protocols to facilitate the users where vehicles cannot be seen approaching such as along blind curves, sand dunes, etc. Further, the communication device is placed anywhere in the vehicle such as on the handlebars or near the steering wheel.

### TECHNICAL FIELD OF THE INVENTION

The present invention generally relates to vehicle-to-vehicle communication devices. More specifically, the present invention relates to a device and method for a vehicle-to-vehicle communication, for example between off-highway vehicles (OHV), to indicate the presence of other nearby OHV without requiring the use of satellite signals or internet access, particularly when a field of view is obscured.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Vehicle-to-vehicle communication enables a vehicle to wirelessly exchange information. Today road safety is one of the major things to be considered in the transport industries. The technical advancement has improved vehicle safety programs to ensure safe and secure travel. One such safety measure is notifying a driver about the upcoming obstacle or blind spot detection in advance so that the driver notices them in time to take appropriate action. This allows the vehicle to communicate with other vehicles when in proximity about the presence of the nearby vehicle by using a warning system or a control system.

There exist various vehicle-to-vehicle communication devices. One example of the same is described herein: a primary vehicle includes a passive transmitter and the secondary vehicle includes a multi-frequency resonance tag/circuit having distinct frequencies for detection and discrimination. The passive transmitter creates electromagnetic waves, which are generated as it passes by the secondary vehicle housing the multi-frequency resonance tag, thereby setting off the secondary vehicle alarm system.

However, the existing vehicle-to-vehicle warning system fails to provide a solution for the specific problem of providing a system that communicates using a communication protocol between various vehicles. A particular problem is observed with off-road or off-highway vehicles (OHV). The problem particularly occurs when visibility is limited due to natural obstacles, such as hill tops, peaks, curved trails and roads, dunes, dust clouds, snow, or other natural or even an-made obstacles that may prevent riders of vehicles otherwise heading towards each other from seeing each other approach.

In some off-road or OHV designated areas, accidents occur including fatal accidents when these areas are frequented and especially during a busy off-roading season. As more riders frequent an off-road designated area, the chances of fatal accidental encounters due to vehicles colliding, with each other and with hikers, increases.

Therefore, there is a need for a device and method for alerting off-roading vehicles about the presence of other vehicles nearby using a communication protocol. Further, there is a need for a device that helps the user to detect when other off-roading vehicles are approaching. Moreover, there remains a need to develop an improved device and method for vehicle-to-vehicle communication to solve the above-mentioned problems.

It is to these ends that the present invention has been developed.

### SUMMARY OF THE INVENTION

The present invention generally discloses a vehicle-to-vehicle communication device. More specifically, the present invention relates to a device and method for a vehicle-to-vehicle communication to indicate the presence of other nearby vehicles to avoid any collision.

In one embodiment, a plurality of vehicles communicating with one another using a device is disclosed. In one embodiment, the device comprises a first communication unit of a first vehicle configured to communicate with a second communication unit of at least one or more other approaching vehicles when in range or proximity thereof. In one embodiment, the first communication unit communicates with the second communication unit via a communication protocol. In one embodiment, the communication protocol includes radio communication and the like. In one embodiment, the communication protocol is used to help users detect when another off-road vehicle is approaching.

In one embodiment, the vehicle-to-vehicle communication device to establish a communication further includes a pedestrian or user with a device. In one embodiment, the device is used by the pedestrian to communication with other devices in range or proximity. In one embodiment, the device is a wearable device, a mobile device, a hand-held device, a portable device, or any other communication device.

In one embodiment, the device is used to alert or indicate to the users or drivers about the presence of other off-roading vehicles nearby. In one embodiment, the alert or indication is an audio signal or a light indication. In one embodiment, the device communicates with other devices with similar communication protocols. In one embodiment, the device is placed on the handlebars of a motorcycle, near the steering wheel of an off-road vehicle, or anywhere on the vehicle. In one embodiment, the device is used to aid along blind curves, sand dunes, etc. where vehicles cannot be seen approaching.

In one embodiment, the device comprises a transceiver unit or transmitter or receiver to transmit or receive the radio signal from vehicle-to-vehicle. The transceiver unit comprises at least one transmitter unit configured to transmit a first signal from the first vehicle. The transmitter is a vehicle communicator. The first signal could contain the details of obstacles, approaching vehicles, people/pedestrians, and the like. The first vehicle comprises a first communication unit configured to communicate with a second communication unit of at least one or more approaching vehicles in the range of proximity. The transceiver unit further comprises at least one receiver unit configured to receive one or more signals from at least one or more approaching vehicles in the proximity.

In one embodiment, the device further includes a controller or CPU to control the operation of the device. The controller unit comprises at least one processor and a memory unit in communication with the processor. The memory unit stores a set of instructions that are executable by the processor configured to control the device operation. In one embodiment, the device further includes a sensor unit or proximity indicator to indicate or alert about the presence of other off-roading vehicles or users nearby. In one embodiment, the device further includes a display unit to display the vehicles in proximity. The display unit is a liquid crystal display (LCD).

Additionally, the devices communicate with the user device using a communication network. The user device provides an additional means of communication between devices. In one embodiment, the user device is any one of a mobile phone, a smart phone, a laptop, a desktop, a personal computer, a personal assistant device, or any other electronic communication devices.

In one embodiment, a method for establishing a vehicle-to-vehicle communication among a plurality of vehicles using a device is envisaged. In one embodiment, the method comprises: facilitating, by the device, communication of a first communication unit of the vehicle with a second communication unit of at least one or more other vehicles from when in range or proximity thereof; receiving, at the second communication unit, a plurality of signals from one or more vehicles via a communication protocol; and alerting the users or drivers of the presence of other off-roading vehicles nearby.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

Various objects and advantages of the present invention will become apparent from the following description taken in conjunction with the accompanying drawings wherein are set forth, by way of illustration and example, certain embodiments of this invention. The drawings submitted herewith constitute a part of this specification, include exemplary embodiments of the present invention, and illustrate various objects and features thereof.

### BRIEF DESCRIPTION OF THE DRAWINGS

The device and method for vehicle-to-vehicle communication as disclosed herein are further described in terms of exemplary embodiments. These exemplary embodiments are described in detail with reference to the drawings, which have not necessarily been drawn to scale in order to enhance their clarity and improve understanding of the various embodiments of the invention. Furthermore, elements that are known to be common and well understood to those in the industry are not depicted in order to provide a clear view of the various embodiments of the invention. These embodiments are non-limiting exemplary embodiments, in which like reference numerals represent similar structures throughout the several views of the drawings. The drawings that accompany the detailed description can be briefly described as follows:

FIG. 1 shows a schematic view of vehicle-to-vehicle communication device among a plurality of vehicles, according to an embodiment of the present invention.

FIG. 2 shows an off-road motorcycle coupled with the vehicle-to-vehicle communication device, according to an embodiment of the present invention.

FIG. 3 shows a block diagram of the device, according to an embodiment of the present invention.

FIG. 4 shows a communication established between the vehicle-to-vehicle communication device and a user device, according to an embodiment of the present invention.

FIG. 5 shows a block diagram depicting a method for vehicle-to-vehicle communication among a plurality of vehicles using a device, according to an embodiment of the present invention.

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention. Wherever possible, the same reference numbers are used in the drawings and the following description to refer to the same or similar elements.

In the following detailed description, numerous specific details are set forth by way of examples in order to provide a thorough understanding of the relevant teachings. However, it should be apparent to those skilled in the art that the present teachings may be practiced without such details. In other instances, well known structures, components and/or functional or structural relationship thereof, etc., have been described at a relatively high-level, without detail, in order to avoid unnecessarily obscuring aspects of the present teachings.

Throughout the specification and claims, terms may have nuanced meanings suggested or implied in context beyond an explicitly stated meaning. Likewise, the phrase “in one embodiment/example” as used herein does not necessarily refer to the same embodiment and the phrase “in another embodiment/example” as used herein does not necessarily refer to a different embodiment. It is intended, for example, that claimed subject matter include combinations of example embodiments in whole or in part.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and or steps. Thus, such conditional language is not generally intended to imply that features, elements and or steps are in any way required for one or more embodiments, whether these features, elements and or steps are included or are to be performed in any particular embodiment.

The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present. The term “and or” means that “and” applies to some embodiments and “or” applies to some embodiments. Thus, A, B, and or C can be replaced with A, B, and C written in one sentence and A, B, or C written in another sentence. A, B, and or C means that some embodiments can include A and B, some embodiments can include A and C, some embodiments can include B and C, some embodiments can only include A, some embodiments can include only B, some embodiments can include only C, and some embodiments include A, B, and C. The term “and or” is used to avoid unnecessary redundancy. Similarly, terms, such as “a, an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

While exemplary embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the invention or inventions disclosed herein. Accordingly, the following detailed description does not limit the disclosure. Instead, the proper scope of the disclosure is defined by the appended claims.

The present disclosure relates to, among other things, a device and method for vehicle-to-vehicle communication. Exemplary embodiments of the present disclosure are described with reference to the drawings for illustration purposes and are not intended to limit the scope of the present disclosure.

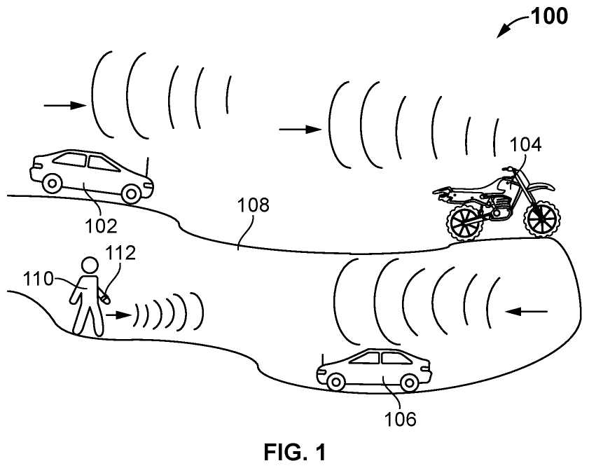

Referring to FIG. 1, a vehicle-to-vehicle communication device 112 to establish a communication 100 between a plurality of vehicles (102, 104, and 106), is illustrated. In one embodiment, the device 112 is an intelligent solution that is designed to alert off-roading vehicles riding in off-road 108 regarding the presence of other approaching vehicles in the nearby vicinity without the use of satellite signals or internet. In one embodiment, the device 112 is used to avoid collisions during travel. In one embodiment, the device 112 is used to aid the users in a place where vehicles cannot be seen approaching.

In one embodiment, a plurality of vehicles (102, 104, and 106) communicating with one another using a communication unit is disclosed (as in FIG. 1). In one embodiment, the plurality of vehicles (102, 104, and 106) include a device 112 attached to them. In one embodiment, a first device comprises a first communication unit of a first vehicle configured to communicate with a second communication unit of at least one or more other approaching vehicles when in range or proximity thereof. In one embodiment, the first communication unit communicates with the second communication unit via a communication protocol. In one embodiment, the communication protocol may be short radio communication or the like. The communication protocol is used to communicate with other similar devices that use the same communications protocol in order to help users detect when another off-road vehicle is approaching. In one embodiment, the communication protocol is used to help users detect when another off-road vehicle is approaching.

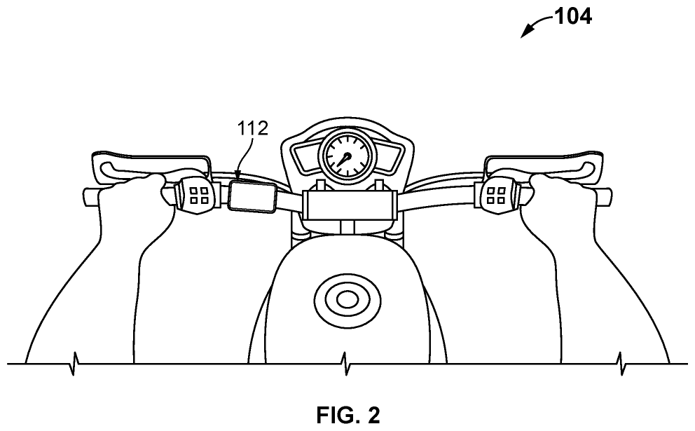

In one embodiment, the device 112 is used to alert or indicate the users or drivers about the presence of other off-roading vehicles nearby. In one embodiment, the alert or indication is in the form of an audio signal or light indication. In one embodiment, the device 112 communicates with other devices using similar communication protocols. The devices 112 may be positioned anywhere on the vehicle. In one embodiment, the device 112 is placed on the handlebars of the motorcycle 104 (as shown in FIG. 2), near the steering wheel, or anywhere on the vehicle.

In one embodiment, the device 112 is used to aid along blind curves, sand dunes, etc. where vehicles cannot be seen approaching. The device 112 is used in off-road situations where the road is not clear and there is less visibility. With dunes, bikers and off-road vehicles cannot see if another rider is on the other side of the dune. This means that vehicles often collide if they do not take appropriate measures including having a lookout. The device 112 mounted on the vehicle has the ability to indicate the riders that other vehicles are approaching, for example, on the other side of the dune.

In one embodiment, the vehicle-to-vehicle communication device to establish a communication 100 further includes a pedestrian or user 110 with a device 112. In one embodiment, the device 112 is used by the pedestrian to communication with other devices in range or proximity. In one embodiment, the device 112 is a wearable device, a mobile device, a hand-held device, a portable device, or any other communication device.

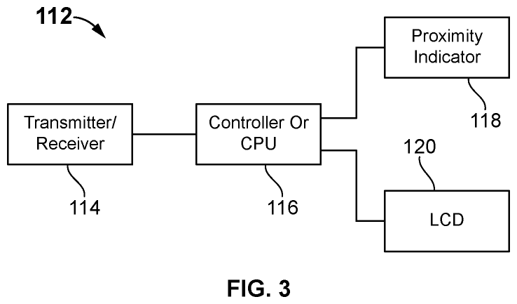

Referring to FIG. 3, a block diagram of the device 112 is illustrated. In one embodiment, the device 112 comprises a transceiver unit or transmitter or receiver 114 to transmit or receive the radio signal from vehicle-to-vehicle. The transceiver unit 114 comprises at least one transmitter unit configured to transmit a first signal from the first vehicle. The transmitter is a vehicle communicator. The first signal could contain the details of obstacles, approaching vehicles, people/pedestrians, and the like. The first vehicle comprises a first communication unit configured to communicate with a second communication unit of at least one or more approaching vehicles in the range of proximity. The transceiver unit 114 further comprises at least one receiver unit configured to receive one or more signals from at least one or more approaching vehicles in the proximity.

In one embodiment, the device 112 further includes a controller or CPU 116 to control the operation of the device 112. The controller unit 116 comprises at least one processor and a memory unit in communication with the processor. The memory unit stores a set of instructions that are executable by the processor configured to control the device operation. In one embodiment, the device 112 further includes a sensor unit or proximity indicator 118 to indicate or alert about the presence of other off-roading vehicles or users nearby. The alert is in the form of an audio signal or light indication. In one embodiment, the device 112 further includes display unit 120 to display the vehicles in proximity. The display unit 120 is a liquid crystal display (LCD).

In one embodiment, the device 112 further comprises additional indicators. The device 112 has indicators to indicate when no service is available. For example, the device 112 has a blind mode when no service is available. Further, the device 112 could be modified to any off-road vehicle such as motorcycle, all-terrain vehicle (ATV), bicycle, car/jeep, and hiker.

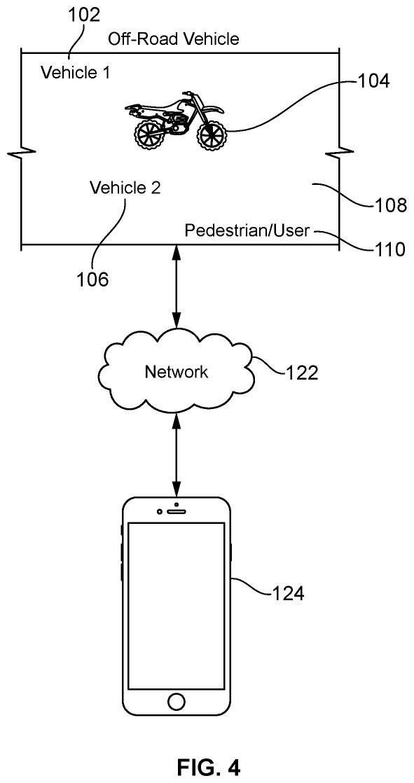

Referring to FIG. 4, a communication established between the plurality of vehicles (102, 104, and 106), pedestrian 110, and a user device 124 is illustrated. Each device (102, 104, and 106) is primarily a standalone device. The devices (102, 104, and 106) communicate with each other when in proximity without the use of internet. In one embodiment, the devices (102, 104, and 106) communicate with each other using a radio frequency (RF) signal. Additionally, the devices (102, 104, and 106) communicate with the user device 124 using a communication network 122. The user device 124 provides an additional means of communication between devices (102, 104, and 106). In one embodiment, the user device 124 is any one of a mobile phone, a smart phone, a laptop, a desktop, a personal computer, a personal assistant device, or any other electronic communication devices. In one embodiment, the communication network 122 could be Bluetooth®, Wi-Fi, WiMAX, wireless local area network (WLAN), satellite networks, cellular networks, private networks, and the like.

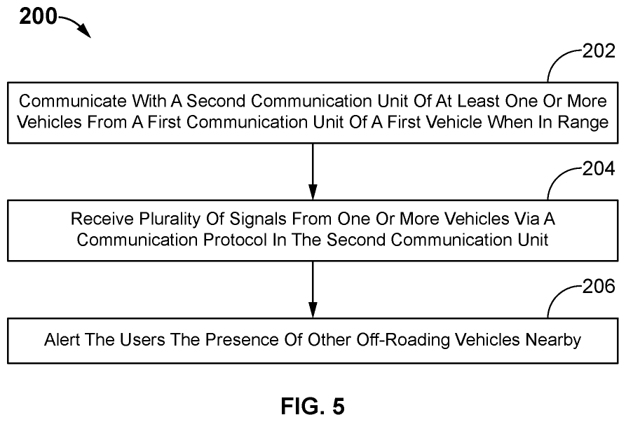

Referring to FIG. 5, a method for establishing vehicle-to-vehicle communication among a plurality of vehicles using a device is illustrated. In one embodiment, the method comprises the following steps. At step 202, the device facilitates communication of a first communication unit of a vehicle with a second communication unit of at least one or more other vehicles when in range or proximity thereof. At step 204, the second communication unit receives a plurality of signals from one or more vehicles via a communication protocol. At step 206, the device alerts the users or drivers of the presence of other off-roading vehicles nearby.

Advantageously, the device of the present invention is used to avoid collisions or accidents that are often the result of blind curves, sand dunes, etc. where vehicles cannot be seen approaching. The device is used to alert off-roading vehicles of the presence of other vehicles nearby without the use of satellite or internet.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

The foregoing detailed description has set forth various embodiments of the devices and/or processes by the use of diagrams, flowcharts, and/or examples. Insofar as such diagrams, flowcharts, and/or examples contain one or more functions and/or operations, it will be understood by those within the art that each function and/or operation within such diagrams, flowcharts, or examples may be implemented, individually and/or collectively, by a wide range of hardware, software, firmware, or virtually any combination thereof.

Those skilled in the art will recognize that it is common within the art to describe devices and/or processes in the fashion set forth herein, and thereafter use engineering practices to integrate such described devices and/or processes into other patient anxiety management systems. That is, at least a part of the devices and/or processes described herein may be integrated into a patient anxiety management system via a reasonable amount of experimentation.

The subject matter described herein sometimes illustrates different components contained within, or connected with, other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

All references, including but not limited to patents, patent applications, and non-patent literature are hereby incorporated by reference herein in their entirety.

A vehicle-to-vehicle communication devices has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

What is claimed is:

1. A device for establishing vehicle-to-vehicle communication among a plurality of vehicles, comprising:
a transceiver unit configured to transmit a signal to approaching vehicles and receive signals from the approaching vehicles;
a controller unit having at least one processor and a memory unit in communication with the processor, wherein the memory unit stores a set of instructions that are executable by the processor configured to control the device operation;
a sensor unit configured to generate an alert to indicate other off-roading vehicles or users nearby, and
a display unit configured to display the vehicles in proximity.

2. The device of claim 1, is installed on each vehicle configured to establish the vehicle-to-vehicle communication among the plurality of vehicles in the proximity.

3. The device of claim 1, communicates with any of the approaching vehicle via a communication unit of the vehicle.

4. The device of claim 1, wherein the transceiver unit comprises at least one transmitter unit configured to transmit a first signal from a first vehicle.

5. The device of claim 4, wherein the first vehicle comprises a first communication unit configured to communicate with a second communication unit of at least one or more approaching vehicles in the range of proximity.

6. The device of claim 1, wherein the transceiver unit comprises at least one receiver unit configured to receive one or more signals from at least one or more approaching vehicles in the proximity.

7. The device of claim 1, establishes communication amount the devices via a communication protocol.

8. The device of claim 1, wherein the sensor unit is a proximity sensor.

9. The device of claim 1, wherein the alert is an audio signal or a light indication.

10. The device of claim 1, wherein the display unit is a liquid crystal display (LCD).

11. The device of claim 1, is selected from the group consisting of a wearable device, a mobile device, a hand-held device, a portable device, or any other communication device.

12. The device of claim 1, further communicates with a user device via a communication network configured to provide additional communication between the vehicles.

13. The device of claim 12, wherein the user device is any one of a mobile phone, a smart phone, a laptop, a desktop, a personal computer, a personal assistant device, or any other electronic communication devices.

14. A method of establishing a vehicle-to-vehicle communication among a plurality of devices using a device having a transceiver unit configured to transmit and receive signals from the approaching vehicles, a controller unit having at least one processor and a memory unit in communication with the processor, wherein the memory unit stores a set of instructions that are executable by the processor configured to control the device operation; and a sensor unit configured to generate an alert to indicate other off-roading vehicles or users nearby, and a display unit configured to display the vehicles in proximity, wherein the method comprises the steps of:
facilitating communication between a first communication unit of a first vehicle and a second communication unit of at least one or more approaching vehicles in a range of proximity;
receiving a plurality of signals from the approaching vehicles via a communication protocol, and
generating an alert to the first vehicle regarding the presence of other off-roading vehicles in the proximity.

15. The method of claim 14, wherein the alert is an audio signal or a light indication.

16. The method of claim 14, further comprising the steps of communicating with a user device via a communication network configured to provide additional communication between the vehicles.

17. The method of claim 16, wherein the user device is any one of a mobile phone, a smart phone, a laptop, a desktop, a personal computer, a personal assistant device, or any other electronic communication devices.
